(19) United States
(12) Patent Application Publication
(10) Pub. No.: US 2010/0011004 A1
(43) Pub. Date: Jan. 14, 2010

(54) Service Identification Optimization

(75) Inventors: Zsolt Rajko, Szechenyi (HU); Gabor Ungvari, Gyal (HU); Zoltan Ban, Budapest (HU); Jozsef Varga, Nagydobsza (HU)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/439,519

(22) PCT Filed: May 29, 2007
(86) PCT No.: PCT/IB2007/052011

§ 371 Date: Aug. 27, 2009

Related U.S. Application Data
(60) Provisional application No. 60/840,716, filed on Aug. 29, 2006.

(51) Int. Cl. G06F 17/30

(52) U.S. Cl. 707/10; 707/E17.001

(57) ABSTRACT

A network element comprising a storage configured to maintain downloaded service profiles; a data base configured to maintain a list of identifiers of downloaded service profiles; and a correspondence processor configured to check the availability of a downloaded service profile by referring to the list of identifiers.

### RELATED APPLICATIONS

This application was originally filed as PCT Application No. PCT/IB2007/052011 filed May 29, 2007, which claims the priority of U.S. Application No. 60/840,716, filed Aug. 29, 2006.

### TECHNICAL FIELD

The present invention relates to the optimization of a service identification. Particularly, the present invention relates to network node, a method and a system which are configured to optimize a service identification.

The present invention can be advantageously applied to the field of IP (internet protocol) multimedia subsystem (IMS).

### BACKGROUND

In general, procedures for handling requests in IMS are described in documents of the 3GPP (3^{rd} generation partnership project), specifically in TS (technical specification) 23.228 (recent version at the time of the present invention: 7.4.0) and TS 24.229 (recent version at the time of the present invention: 7.4.0).

These documents 3GPP TS 23.228 and 24.229 define two distinct ways how a terminating request for a PSI (public service identifier) can be routed to an AS (application server) hosting the PSI. The public service identity (PSI) is an identity that identifies a service or a specific resource created for a service in an application server. The public service identity (PSI) is in the form of a SIP (session initiation protocol) uniform resource identifier (URI) or a TEL URI. It can identify, for example, presence, messaging, conferencing, and group services. Further, under a PSI routing is to be understood a routing of SIP messages in the IP multimedia subsystem (IMS) from a user to a service with the public service identity (PSI). The PSI routing can be direct routing, or it can be based on a sub-domain or on the IP multimedia subsystem routing principles.

It shall be considered the scenario when such a terminating request is routed to an S-CSCF (serving call state control function) and from S-CSCF to the AS through ISC (IMS service control) interface. In this scenario the (distinct or wildcarded) PSI is configured to the HSS (home subscriber server). A wildcarded PSI means here a range of public service identities (PSI) in which the ad hoc public service identities that the user has created are matched. The variable part in the wildcarded PSI is in the user part of the uniform resource identifier. The public service identities that are used in routing are matched to the wildcarded PSI in the user mobility server (UMS) as part of HSS. Upon a terminating request, the I-CSCF (interrogating call state control function) makes a location info query to the HSS. In response to the query, the I-CSCF selects a S-CSCF and routes the request to it. The service profile for the PSI could be either statically configured to the S-CSCF (which significantly increases the complexity of the network configuration and is not acceptable for many operators) or could be downloaded from the HSS via existing server assignment procedures.

Downloading the PSI service profile to the S-CSCF is reasonable when the first terminating request is served in the S-CSCF, but unnecessary when later on a terminating request for a same PSI is served by the S-CSCF.

To the documents 3GPP TS 23.228 and 24.229 describing such procedures for PSI routing, there is a change request that describes a solution in which HSS returns an identifier of PSI profile to the I-CSCF in the response for location information query (LIR—location information request). The I-CSCF optionally inserts the received profile identifier to a SIP (session initiation protocol) message to a new SIP header introduced by a working group of the internet engineering task force with a so-called internet draft as a work in progress that is sent to a S-CSCF. This new Sip header is called P-Profile-Key P-header and contains the key to be used by a proxy to query the user database for a given profile. The augmented Backus-Naur Form (BNF) syntax of the P-Profile-Key header field is the following:

P-Profile-Key=

“P-Profile-Key” HCOLON (name-addr/addr-spec)

*(SEMI generic-param)

The format of HCOLON, name-addr, addr-spec, and generic-param are defined in the internet engineering task force's request for comment RFC 3261. With respect thereto, the format of wildcarded public service identities is defined in 3GPP TS 23.003. The following is an example of a P-Profile-Key header field that contains a wildcarded public service identity:

P-Profile-Key:<chatroom-!.*!@example.com>

When the S-CSCF requests download of a service profile from the HSS, it inserts the received profile identifier to the request, thus the HSS can avoid identifying the service profile again (based on the content of a R-URI—request uniform resource identity) and can use the profile identifier directly to find the proper profile in the database.

Thus, this change request provides a solution for avoiding service profile identification to be done twice (once when I-CSCF makes location info query, second time when S-CSCF downloads the profile) for a terminating SIP request.

### SUMMARY OF THE INVENTION

It is an object of the present invention to still more improve the known solutions for a still more optimized service identification.

According to a first aspect of the present invention, this is accomplished by a network element such as a network node comprising a storage configured to maintain downloaded service profiles; a data base configured to maintain a list of identifiers of downloaded service profiles; and a correspondence processor configured to check the availability of a downloaded service profile by referring to the list of identifiers.

This aspect may be modified by further comprising a receiver for receiving a request including an identifier for a service profile, wherein the receiver is configured to forward the request to the correspondence processor.

The identifier may be a wildcarded PSI value, and the identifier may be received in a P-Profile-Key P-header.

According to a second aspect of the present invention, the above object is accomplished by a network element such as a network node comprising storage means configured to maintain downloaded service profiles; data base means configured to maintain a list of identifiers of downloaded service profiles; and correspondence means configured to check the availability of a downloaded service profile by referring to the list of identifiers.

According to a third aspect of the present invention, the above object is accomplished by a method comprising maintaining downloaded service profiles; maintaining a list of identifiers of downloaded service profiles; and checking the availability of a downloaded service profile by referring to the list of identifiers.

This aspect may be modified by further comprising one or more of receiving a request including an identifier for a service profile, and downloading a service profile if it is not available.

The method may be executed in a serving call state control function, the identifier may be inserted into the request by an interrogating call state control function, and the download may be executed from a home subscriber server.

The identifier may be a wildcarded PSI value, and the identifier may be received in a P-Profile-Key P-header.

According to a fourth aspect of the present invention, the above object is accomplished by a system comprising a first network element configured to maintain downloaded service profiles; a second network element configured to maintain a list of identifiers of downloaded service profiles; and a third network element configured to check the availability of a downloaded service profile by referring to the list of identifiers.

This aspect may be modified by one or more of the following. The third network element may be further configured to receive a request including an identifier for a service profile, or the system may comprise a fourth network element configured to receive a request including an identifier for a service profile and to forward the request to the third network element. The system may also further comprise a fifth network element configured to download a service profile if it is not available.

One or more of the first to fifth network elements may be comprised in a single physical entity. This entity may be a serving call state control function. The request including an identifier for a service profile may be an interrogating call state control function. The service profile may be downloaded from a home subscriber server.

The identifier may be a wildcarded PSI value, and the identifier may be received in a P-Profile-Key P-header.

According to a fifth aspect of the present invention, the above object is accomplished by a system comprising a first means for maintaining downloaded service profiles; second means for maintaining a list of identifiers of downloaded service profiles; and third means for checking the availability of a downloaded service profile by referring to the list of identifiers.

Accordingly, advantage can be achieved in that unnecessary service profile downloads from the HSS are avoided, a redundant network configuration where e.g. service profile identifier are configured in several network elements are avoided, and the execution of the same task such as the identification of the service profile identifier several times (by different network elements) for a terminating request is also avoided. It is to be noted here that the identification that a certain URI falls to the range of wildcarded service identifier can be a very costly operation.

### BRIEF DESCRIPTION OF THE DRAWINGS

These and other aspects, modifications, features, and advantages of the present invention become more fully apparent from the following description of the preferred embodiments thereof which is to be taken in conjunction with the appended drawings, in which:

FIG. 1 shows a signaling sequence for a terminating public service identifier routing for a scenario when a service profile of a target public service identifier is already downloaded to a S-CSCF as an embodiment of the present invention; and

FIG. 2 shows an implementation example of another embodiment of the present invention.

### DESCRIPTION OF THE PREFERRED EMBODIMENTS

Embodiments of the present invention relate to service request handling in IMS (IP multimedia subsystem), especially to a scenario when a SIP (session initiation protocol) request is targeted to a PSI (public service identity) hosted by an AS (application server). The IMS utilizes the SIP for initiating and controlling service requests.

When, within the framework of IMS, an I-CSCF makes a location info query to a HSS and the HSS detects that the target is a PSI, then it returns the PSI (either a distinct PSI or a wildcarded PSI in case the target falls in the range defined by a wildcarded PSI) in the response. The I-CSCF puts the PSI as additional information to the SIP message which is forwarded to S-CSCF.

When S-CSCF receives a SIP message which includes this additional information (i.e. the PSI) it checks if the service profile for the given PSI has been already downloaded to the S-CSCF or not. If the service profile has not been downloaded yet, then the S-CSCF has to download that from HSS via existing procedures, but otherwise the S-CSCF skips the unnecessary server assignment procedure.

Thus, the S-CSCF maintains a list of service profile identifiers for which the service profile has been downloaded and available in the S-CSCF so that when the S-CSCF receives a SIP request that includes profile identifier, it checks if the corresponding profile is already available in S-CSCF.

According to an embodiment of the present invention, the procedures of S-CSCF could be extended as follows.

When the S-CSCF receives a terminating SIP request that contains the service profile identifier inserted by the I-CSCF as described above, then the S-CSCF checks if the service profile for the given identifier has been downloaded or not. The S-CSCF uses the identifier inserted by the I-CSCF to decide whether the target matches to a PSI for which the service profile is downloaded. This matching is significantly more efficient than checking again if the target URI falls to the range defined by a wildcarded PSI. If the service profile has been already downloaded, then the S-CSCF can skip the server assignment procedure. Otherwise, the S-CSCF can initiate the server assignment in order to download the PSI service profile from the HSS.

Accordingly, these embodiments can achieve the benefits of a more efficient procedure for serving terminating requests for PSI. More specifically, an optimization such as the skipping of the server assignment procedure can be done for all the terminating SIP requests to the PSI, except for the first one, at which the PSI service profile is downloaded to S-CSCF. When the S-CSCF looks up a stored service profile for the PSI, it does not have to match the target URI to ranges defined by wildcarded PSI, since the wildcarded PSI itself is available in the SIP message and thus can be directly compared to any stored wildcarded PSI. This is very important as it would be inefficient to make the same target URI versus wildcarded PSI range matching that has been already done in HSS once more in the S-CSCF.

Apart from that, it is not necessary to change the procedure for terminating a SIP request to non-PSI, i.e. to normal users. Further, it is not required that PSI are statically configured to serving call stat control functions. This is considered as an important benefit, since operators may not prefer the configuring of PSI to every network element.

Moreover, according to the above description, embodiments of the present invention can take influence on the SIP and Cx interface signaling between I-CSCF, HSS and S-CSCF.

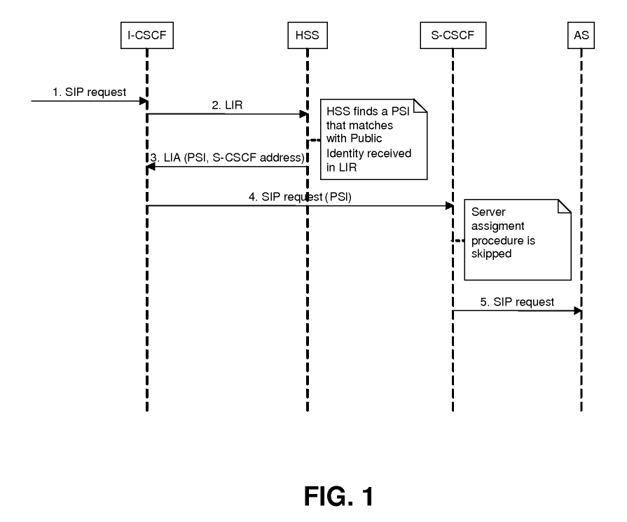

The above is illustrated in still more detail by referring to FIG. 1 which shows a signaling sequence for a terminating public service identifier routing for a scenario when a service profile of a target public service identifier is already downloaded to a S-CSCF as an embodiment of the present invention.

This figure shows examples for a system and a method according to the present invention.

In detail, FIG. 1 shows that, firstly (1.), an I-CSCF receives a terminating SIP request. The Request-URI of the SIP request contains a PSI. The I-CSCF makes LIR (location information request) query (2.) to a HSS. The HSS checks the content of the public-identity AVP (attribute value pair) and finds that it either matches with a distinct PSI or falls to the range defined by a wildcarded PSI. Then, the HSS sends (3.) a LIA (location information answer to the I-CSCF. The message includes a S-CSCF address and the (distinct or wildcarded) PSI as well. Next, the I-CSCF sends (4.) the SIP request to the S-CSCF. The SIP request includes the PSI received from the HSS, but the original Request-URI is not changed. The S-CSCF recognizes the PSI in the SIP request in a maintained list and finds the service profile downloaded for the given PSI. Thus, the server assignment procedure is skipped. Finally, the AS (application server) hosting the PSI is part of the service profile, so that the SIP request can be routed to the AS.

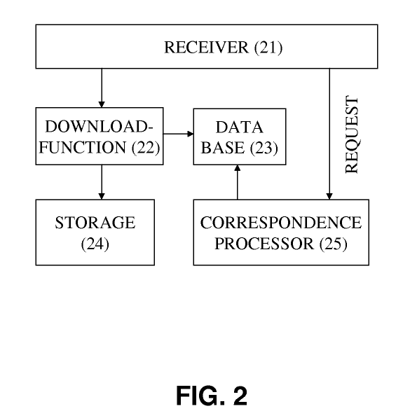

In order to further illustrate the system and network element according to embodiments of the present invention, FIG. 2 shows implementation examples of functionalities according to embodiments of the present invention. Reference numeral 21 designates a receiver for receiving a request including a service identifier. The receiver forwards this request to a correspondence processor which is designated by the reference numeral 25. The correspondence processor looks up a data base bearing the reference numeral 23 which includes service identifiers for service profiles which have already been downloaded by a download function 22. If it turns out that the service identifier is included in the data base 23, then the corresponding service profile is available in a storage 24, to which the service profile has been previously downloaded. If the service identifier cannot be found in the data base, the download function is prompted to download the corresponding service profile e.g. via the receiver 21.

The elements shown in FIG. 2 may altogether or in part by implemented in a single network element, or form a distributed functionality so as to rather constitute a system. As an embodiment of the present invention, the elements shown in FIG. 2 may be implemented in the S-CSCF shown in FIG. 1.

In addition, certain embodiments of the present invention can enable that all operators implementing an IMS network can benefit from the use of the present invention.

The embodiments described above may be also implemented in any combination.

While it has been described above what are presently considered to be preferred embodiments of the present invention, it is to be understood that these are only illustrative of nature and not intended to limit the present invention in any way.

1. An apparatus, comprising;
a storage configured to maintain downloaded service profiles;
a data base configured to maintain a list of identifiers of downloaded service profiles; and
a correspondence processor configured to check the availability of a downloaded service profile by referring to the list of identifiers.

2. The apparatus according to claim 1, further comprising a receiver for receiving a request including an identifier for a service profile, wherein the receiver is configured to forward the request to the correspondence processor.

3. The apparatus according to claim 2, wherein the identifier is a wildcarded PSI value, and the identifier is received in a P-Profile-Key P-header.

4. A method comprising
maintaining downloaded service profiles by a storage;
maintaining a list of identifiers of downloaded service profiles by a database; and
checking the availability of a downloaded service profile by referring to the list of identifiers by a correspondence processor.

5. The method according to claim 4, further comprising one or more of receiving a request including an identifier for a service profile, and downloading a service profile if it is not available.

6. The method according to claim 5, wherein the method is executed in a serving call state control function, the identifier is inserted into the request by an interrogating call state control function, and the download is executed from a home subscriber server.

7. The method according to claim 5, wherein the identifier is a wildcarded PSI value, and the identifier is received in a P-Profile-Key P-header.

8-15. (canceled)

16. The system according to claim 6, wherein the identifier is a wildcarded PSI value, and the identifier is received in a P-Profile-Key P-header.

17. An apparatus, comprising:
means for maintaining downloaded service profiles;
means for maintaining a list of identifiers of downloaded service profiles; and
means for checking the availability of a downloaded service profile by referring to the list of identifiers.
